(19) United States
(12) Patent Application Publication
(10) Pub. No.: US 2005/0274158 A1
(43) Pub. Date: Dec. 15, 2005

(54) Drain pump and drum type washing machine having the same

(75) Inventor: Jae Myong Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/125,172

(22) Filed: May 10, 2005

(30) Foreign Application Priority Data
Jun. 15, 2004 (KR) 2004-44042

(51) Int. Cl. B08B 3/12

(52) U.S. Cl. 68/19; 68/208

(57) ABSTRACT

A drain pump and drum type washing machine having the same. The drum type washing machine is designed to prevent water, remaining in the drain pump, from being frozen, to thereby avoid malfunction of the drain pump. The drum type washing machine includes a housing defining an outer appearance of the washing machine, a water tub installed in the housing to contain water therein, a drain pump disposed below the water tub to generate a pumping force required to suction the water from the water tub and externally drain the water, and a water suction device connected with the drain pump to suction the water remaining in the drain pump. When the peripheral temperature falls below zero, the water suction device suctions the water remaining in the drain pump, such that substantially no water remains in the drain pump. The present invention prevents the water in the drain pump from being frozen, thereby avoiding a malfunction of the drain pump.

### CROSS-REFERENCE TO RELATED APPLICATIONS

This application claims the benefit of Korean Patent Application No. 2004-0044042, filed on Jun. 15, 2004 in the Korean Intellectual Property Office, the disclosure of which is incorporated herein by reference.

### BACKGROUND OF THE INVENTION

1. Field of the Invention

The present invention relates to a drain pump and a drum type washing machine having the same, and, more particularly, to a drum type washing machine which can prevent water inside a drain pump thereof from being frozen, to thereby avoid a malfunction of the drain pump.

2. Description of the Related Art

In general, a drum type washing machine is an apparatus for washing laundry by repeatedly performing washing and rinsing operations. Such a drum type washing machine is adapted to repeatedly raise and drop the laundry, such that the laundry is washed by virtue of its dropping force.

The drum type washing machine includes a housing defining the outer appearance of the washing machine, a cylindrical water tub installed in the housing to contain water therein, and a rotating tub rotatably installed in the water tub. As the rotating tub rotates, the laundry, placed in the rotating tub, can be washed.

The drum type washing machine further includes a water supply device to supply hot and cold water into the water tub, and a drain device adapted to drain the water, used in the washing of the laundry, from the water tub. The drain device includes a drain hose to externally drain the water from the water tub, and a drain pump disposed below the water tub to generate a pumping force required to externally drain the water through the drain hose.

However, in the conventional drum type washing machine, even after the water is completely drained to the outside of the washing machine, a certain amount of water remains in the drain pump. When the peripheral temperature of the washing machine drops below zero, the water remaining in the drain pump, may be frozen, thereby causing a malfunction of the drain pump.

### SUMMARY OF THE INVENTION

Accordingly, it is an aspect of the invention is to provide a drain pump and a washing machine having the same, which can prevent water remaining in the drain pump from being frozen, thereby avoiding a malfunction of the drain pump.

Additional aspects and/or advantages of the invention will be set forth in part in the description which follows and, in part, will be obvious from the description, or may be learned by practice of the invention.

The foregoing and/or other aspects of the present invention are achieved by providing a drum type washing machine including a housing defining an outer appearance of the washing machine, a water tub installed in the housing to contain water, a drain pump disposed below the water tub to generate a pumping force required to suction the water from the water tub and externally drain the water, and a water suction device connected with the drain pump to suction the water remaining in the drain pump.

The water suction device may suction the water, remaining in the drain pump, according to a fall of the peripheral temperature of the washing machine.

The water suction device may include a water suction container internally defining an air receiving space and communicating with the drain pump.

The water suction device may further include a guiding pipe provided between the drain pipe and the water suction container, wherein a lower end of the guiding pipe is connected with a lower portion of the drain pump, and an upper end of the guiding pipe is connected with a bottom of the water suction container to guide a flow of the water between the drain pump and the water suction container.

The water suction container may be positioned adjacent to a bottom of the water tub to receive heat transferred from the water contained in the water tub.

It is another aspect of the present invention to provide a drain pump to generate a pumping force required to suction water, and to externally drain the water in a forcible flow manner from an apparatus, the drain pump including a water suction device to adjust the amount of water, remaining in the drain pump, according to a peripheral temperature of the apparatus.

The water suction device may suction the water, remaining in the drain pump, according to a fall of the peripheral temperature of the apparatus.

The water suction device may include a water suction container internally defining an air receiving space and communicating with the drain pump.

The water suction device may further include a guiding pipe provided between the drain pipe and the water suction container, wherein a lower end of the guiding pipe is connected with a lower portion of the drain pump, and an upper end of the guiding pipe is connected with the bottom of the water suction container to guide a flow of the water between the drain pump and the water suction container.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a side sectional view illustrating a drum type washing machine having a drain pump in accordance with an embodiment of the present invention; and

FIG. 2 is a side sectional view illustrating a drum type washing machine in accordance with another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Reference will now be made in detail to the embodiments of the present invention, examples of which are illustrated in the accompanying drawings, wherein like reference numerals refer to the like elements throughout. The embodiments are described below to explain the present invention by referring to the figures.

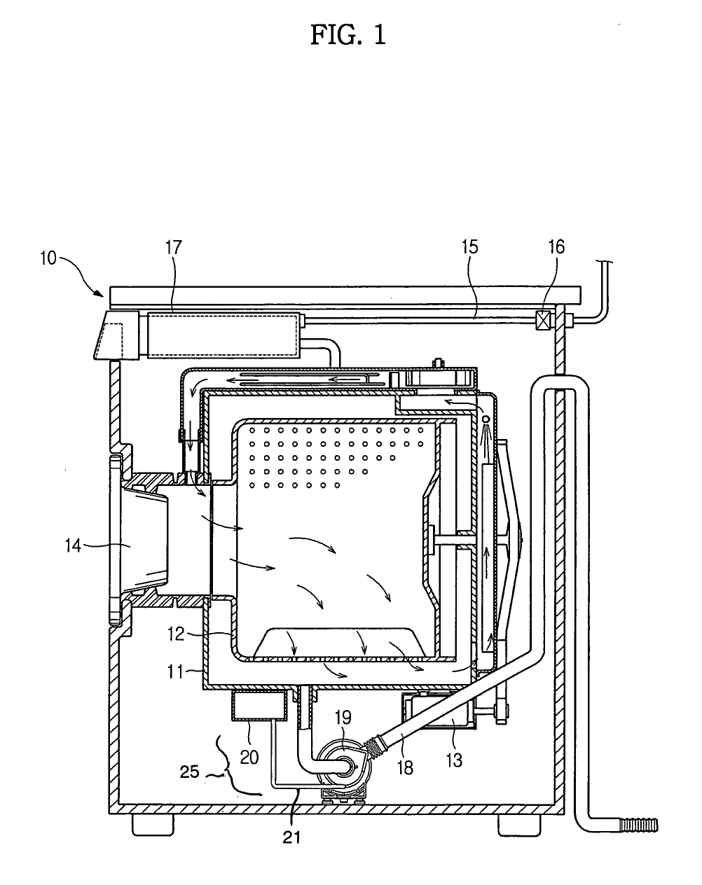

FIG. 1 is a side sectional view illustrating a drum type washing machine having a drain pump in accordance with an embodiment of the present invention. As shown in FIG. 1, the drum type washing machine of the present invention includes a housing 10 defining the outer appearance of the washing machine, a water tub 11 suspended in the housing 10 to contain water therein, and a rotating tub 12 rotatably installed in the water tub 11 to rotate upon receiving a rotating force generated by a driving motor 13.

Openings are provided at respective front ends of the water tub 11 and the rotating tub 12 to allow laundry to be put into or taken out of the rotating tub 12 therethrough. A door 14 is hingably mounted to a front wall of the housing 10 to open or close the openings of the water tub 11 and the rotating tub 12.

Installed at the top of the housing 10 are a water supply pipe 15 to receive hot and cold water from an external water supply source, a water supply valve 16 to open or close the water supply pipe 15, and a detergent container 17 to contain detergent and mix the detergent with the water supplied via the water supply pipe 15. At the bottom of the housing 10 are installed a drain hose 18 to externally drain the water from the water tub 11 after completion of a wash cycle, and a drain pump 19 to generate a pumping force required to externally drain the water through the drain hose 18.

The drain hose 18 is bent to have an inverted U-shaped middle portion, in order to allow the water, discharged from the drain pump 19, to be successively guided upward and downward. The drain pump 19 is disposed below the water tub 11, and one end of the drain hose 18 is installed at a discharge side of the drain pump, such that the water can be forcibly drained to the outside of the housing 10 through the drain hose 18.

Such a configuration of the drain pump 19 and the drain hose 18 has an inherent problem in that a certain amount of water inevitably remains in the drain pump 19 even after completing a drain cycle. When the peripheral temperature of the washing machine drops below zero, the water remaining in the drain pump 19 after the drain cycle, may be frozen and thus cause a malfunction of the drain pump 19. Therefore, in order to prevent such malfunction of the drain pump 19, according to the present invention, a water suction device 25 is provided beside the drain pump 19, to suction the water inside the drain pump 19.

The water suction device 25 adjusts the amount of water remaining in the drain pump 19, according to the peripheral temperature of the washing machine. That is, when the peripheral temperature drops below zero the water suction device 25 minimizes the amount of the water remaining in the drain pump 19, thereby preventing the water in the drain pump 19 from being frozen, to avoid a malfunction of the drain pump 19.

In FIG. 1, the water suction device 25 includes a water suction container 20 internally defining an air receiving space, and a guiding pipe 21 which is connected at a lower end thereof with a lower portion of the drain pump 19 and at an upper end thereof with the bottom of the water suction container 20 to guide the flow the water between the drain pump 19 and the water suction container 20. The water suction device 25 operates when air expands or contracts according to a rise or a fall of the temperature of the washing machine, causing a variation in a volume thereof. That is, when the temperature falls, the volume of the air, received in the water suction container 20 decreases, and thus generates a suction force sufficient to suction the water remaining in the drain pump 19, through the guiding pipe 21 to thereby decrease the amount of water remaining in the drain pump 19. On the contrary, when the temperature rises, the volume of the air, received in the water suction container 20 increases, and thus generates a discharge force sufficient to discharge the sucked water toward the drain pump 19.

The water suction container 20 may be positioned adjacent to the bottom of the water tub 11, such that it can easily receive heat transferred from the water contained in the water tub 11. Since during the winter, water having a higher temperature than the peripheral temperature of the washing machine, is supplied into the water tub 11, the air received in the water suction container 20 is first heated and expands upon receiving the heat transferred from the high-temperature water of the water tub 11, and then is cooled and contracts by the peripheral temperature, thereby allowing the water, remaining in the drain pump 19, to be suctioned into the water suction container 20. Therefore, as a temperature of the air received in the water suction container 20 decreases, the amount of the water to be suctioned into the water suction container 20 increases.

When the drum type washing machine according to the present invention is operated in the winter, the air, received in the water suction container 20, initially expands upon receiving the heat transferred from the water contained in the water tub 11, and thus acts to discharge the water, previously suctioned into the water suction container 20, toward the drain pump 19. Then, in a state wherein the majority of the water contained in the water tub 11 is externally drained through the drain hose 18, and a small amount of the water remains in the drain pump 19, the air, received in the water suction container 20, is cooled and contracts by the low peripheral temperature, and thus acts to suction the water in the drain pump 19, thereby allowing substantially no water to remain in the drain pump 19.

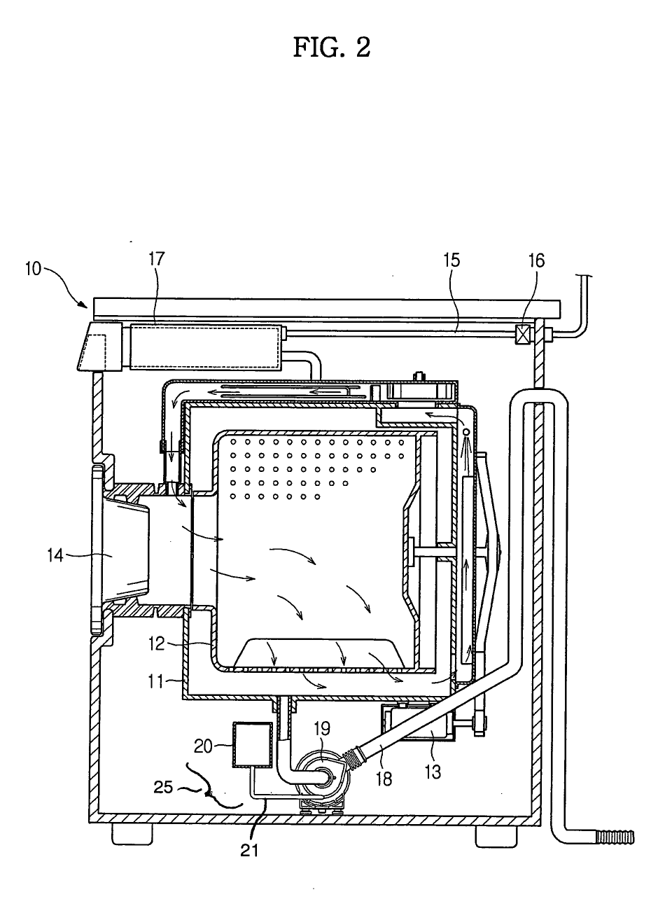

In the present embodiment, the water suction container 20 is installed adjacent to a bottom of the water tub 11. However, the installation position of the water suction container 20 can be altered without limitation, and thus may be independently positioned with the water tub 11 as shown in FIG. 2.

As is apparent from the above description, a drum type washing machine according to the present invention includes a drain pump provided with a water suction device to suction water remaining in the drain pump when the peripheral temperature drops below zero in the winter, such that substantially no water remains in the drain pump. Therefore, the present invention prevents the water in the drain pump from being frozen, to thereby avoid a malfunction of the drain pump.

Although a few embodiments of the present invention have been shown and described, it would be appreciated by those skilled in the art that changes may be made in these embodiments without departing from the principles and spirit of the invention, the scope of which is defined in the claims and their equivalents.

1. A drum type washing machine comprising:
a housing defining an outer appearance of the washing machine;
a water tub installed in the housing and to contain water therein;
a drain pump disposed below the water tub to generate a pumping force required to suction the water from the water tub and externally drain the water; and
a water suction device connected to the drain pump to suction the water remaining in the drain pump.

2. The washing machine according to claim 1, wherein the water suction device suctions the water, remaining in the drain pump, according to a fall of the peripheral temperature of the washing machine.

3. The washing machine according to claim 2, wherein the water suction device comprises a water suction container internally defining an air receiving space and communicating with the drain pump.

4. The washing machine according to claim 3, wherein the water suction device further comprises a guiding pipe provided between the drain pipe and the water suction container, wherein a lower end of the guiding pipe is connected with a lower portion of the drain pump, and an upper end of the guiding pipe is connected with a bottom of the water suction container to guide a flow of the water between the drain pump and the water suction container.

5. The washing machine according to claim 3, wherein the water suction container is positioned adjacent to a bottom of the water tub to receive heat transferred from the water contained in the water tub.

6. The drum type washing machine according to claim 2, wherein when the peripheral temperature falls, the water suction device suctions the water remaining in the drain pump, and when the peripheral temperature rises the water suction device discharges the sucked water toward the drain pump.

7. The drum type washing machine according to claim 3, wherein when the peripheral temperature falls, the water suction device suctions the water remaining in the drain pump through the guiding pipe into the water suction device, and when the peripheral temperature rises the water suction device discharges the sucked water toward the drain pump.

8. A drain pump to generate a pumping force required to suction water, and to externally drain the water in a forcible flow manner from an apparatus, the drain pump comprising:
a water suction device to adjust an amount of water remaining in the drain pump, according to a peripheral temperature of the apparatus.

9. The drain pump according to claim 8, wherein the water suction device suctions the water remaining in the drain pump, according to a fall of the peripheral temperature of the apparatus.

10. The drain pump according to claim 9, wherein the water suction device comprises a water suction container internally defining an air receiving space and communicating with the drain pump.

11. The drain pump according to claim 10, wherein the water suction device further comprises a guiding pipe provided between the drain pipe and the water suction container, wherein a lower end of the guiding pipe is connected with a lower portion of the drain pump, and an upper end of the guiding pipe is connected with a bottom of the water suction container to guide a flow of the water between the drain pump and the water suction container.

12. The drain pump according to claim 9, wherein when the peripheral temperature falls, the water suction device suctions the water remaining in the drain pump, and when the peripheral temperature rises the water suction device discharges the sucked water toward the drain pump.

13. The drain pump according to claim 10, wherein when the peripheral temperature falls, the water suction device suctions the water remaining in the drain pump through the guiding pipe into the water suction device, and when the peripheral temperature rises the water suction device discharges the sucked water toward the drain pump.
